(19) United States
(12) Patent Application Publication
(10) Pub. No.: US 2026/0163984 A1
(43) Pub. Date: Jun. 11, 2026

(54) REUSE DETERMINATION SYSTEM AND STORAGE MEDIUM INCLUDING REUSE DETERMINATION PROGRAM

(71) Applicant: KONICA MINOLTA, INC., Tokyo (JP)

(72) Inventor: Kenzo YAMAMOTO, Toyohashi-shi (JP)

(73) Assignee: KONICA MINOLTA, INC., Tokyo (JP)

(21) Appl. No.: 19/403,817

(22) Filed: Nov. 29, 2025

(30) Foreign Application Priority Data
Dec. 9, 2024 (JP) 2024-214232

(51) Int. Cl. H04N 1/00

(52) U.S. Cl. CPC H04N 1/00034; H04N 1/00061; H04N 2201/0094

(57) ABSTRACT

A reuse determination system includes a hardware processor. The hardware processor, acquires use information of a user, sets, based on the acquired use information, a second determination standard according to a first determination standard preliminarily classified in stages, determines whether an image forming apparatus and/or a unit built in the image forming apparatus satisfies the set second determination standard, and decides the image forming apparatus which is to be a reuse candidate based on a determination result.

### CROSS-REFERENCE TO RELATED APPLICATION

The entire disclosure of Japanese Patent Application No. 2024-214232, filed on Dec. 9, 2024, including description, claims, drawings and abstract is incorporated herein by reference.

### BACKGROUND OF THE INVENTION

### Technical Field

The present disclosure relates to a reuse determination system and a storage medium including a reuse determination program.

### Description of Related Art

In recent years, for the purpose of effective use of resources, it has been required to eliminate wasteful discard in order to realize a circulatory society. For example, in the technical field of image forming apparatuses, necessary maintenance is performed on the image forming apparatus collected from an office or the like, and the image forming apparatus is reused as a “refurbished machine” that is a maintenance finished product.

For example, a system has been proposed in which a destination of reuse for a unit removed from an image forming apparatus that is to be a discarded target is decided based on a remaining lifetime of the unit (see Japanese Unexamined Patent Publication No. 2011-085786). Thus, the usable unit can be allocated to another image forming apparatus suitable for reuse without being discarded.

However, it is not possible to judge an appropriate reuse destination of the image forming apparatus according to the use status of the user at a delivery destination only by information on the remaining lifetime of the unit.

For example, a number of printable sheets is set in advance for each unit built in the image forming apparatus, such as 60000 sheets for a fixing unit and a belt unit and 120000 sheets for a roller unit. Note that the number of printable sheets is merely an example, and the number is not limited to this.

When a threshold value of the determination standard relating to the remaining lifetime of the unit judged to be reusable is set to 30% or more, the image forming apparatus in which the fixing unit having the remaining lifetime of 31% is incorporated is judged to be reusable.

However, in a case where the above-described image forming apparatus is installed for a user who prints a large number of sheets per month, the remaining lifetime of the unit will soon fall below the above-described threshold value. Furthermore, it does not take much time from the installation of the image forming apparatus until the remaining lifetime that requires the replacement of the unit becomes 0%. Therefore, unit replacement work occurs immediately after the installation of the image forming apparatus, which may cause user dissatisfaction.

Here, in the present specification, the “remaining lifetime” in the unit of the image forming apparatus is expressed as a percentage by subtracting an actual number of printed sheets (e.g., 30000 sheets) on which printing or the like has been performed through use of the image forming apparatus so far from the number of printable sheets (e.g., 60000 sheets) of each unit set in advance in a completely new state, further dividing by the number of printable sheets, and then multiplying by 100.

In the case of the above example, the remaining lifetime is calculated as (60000-30000)÷60000×100=50%. As the value of the remaining lifetime is larger, a period until replacement of each unit becomes longer.

### SUMMARY OF THE INVENTION

An object of the present disclosure is to provide a reuse determination system capable of appropriately determining whether an image forming apparatus can be reused based on a use status of a user who uses the image forming apparatus, and a storage medium having a reuse determination program.

According to one aspect of the present disclosure, a reuse determination system reflecting one aspect of the present disclosure includes:
a hardware processor,
wherein the hardware processor,
acquires use information of a user,
sets, based on the acquired use information, a second determination standard according to a first determination standard preliminarily classified in stages,
determines whether an image forming apparatus and/or a unit built in the image forming apparatus satisfies the set second determination standard, and
decides the image forming apparatus which is to be a reuse candidate based on a determination result.

According to another aspect of the present disclosure, a non-transitory computer-readable storage medium reflecting one aspect of the present disclosure is a storage medium including a reuse determination program that causes a computer to perform,
acquiring use information of a user,
setting, based on the acquired use information, a second determination standard according to a first determination standard preliminarily classified in stages,
determining whether an image forming apparatus and/or a unit built in the image forming apparatus satisfies the set second determination standard, and
deciding the image forming apparatus which is to be a reuse candidate based on a determination result.

### BRIEF DESCRIPTION OF THE DRAWINGS

The advantages and features provided by one or more embodiments of the invention will become more fully understood from the detailed description given hereinafter and the appended drawings which are given by way of illustration only, and thus are not intended as a definition of the limits of the present disclosure, and wherein:

FIG. 1 is an explanatory diagram illustrating an outline of a system configuration of a reuse determination system of the present disclosure;

FIG. 2 is a flowchart illustrating an example of a flow of a process of the reuse determination system;

FIG. 3 is an explanatory diagram illustrating an example of a determination standard table;

FIG. 4 is an explanatory diagram schematically illustrating remaining lifetime of a fixing unit, a belt unit, and a roller unit;

FIG. 5 is an explanatory diagram schematically illustrating the remaining lifetime of the fixing unit, the belt unit, and the roller unit;

FIG. 6 is an explanatory diagram schematically illustrating the remaining lifetime of the fixing unit, the belt unit, and the roller unit; and

FIG. 7 is a flowchart illustrating an example of a flow of processing of the reuse determination system including a device extraction means.

### DETAILED DESCRIPTION

Hereinafter, one or more embodiments of the present disclosure will be described with reference to the drawings. However, the scope of the invention is not limited to the disclosed embodiments.

In the following, embodiments of a reuse determination system and a reuse determination program of the present disclosure will be described with reference to the drawings. However, the scope of the present disclosure is not limited to the following examples illustrated in the drawings.

### 1. Reuse Determination System

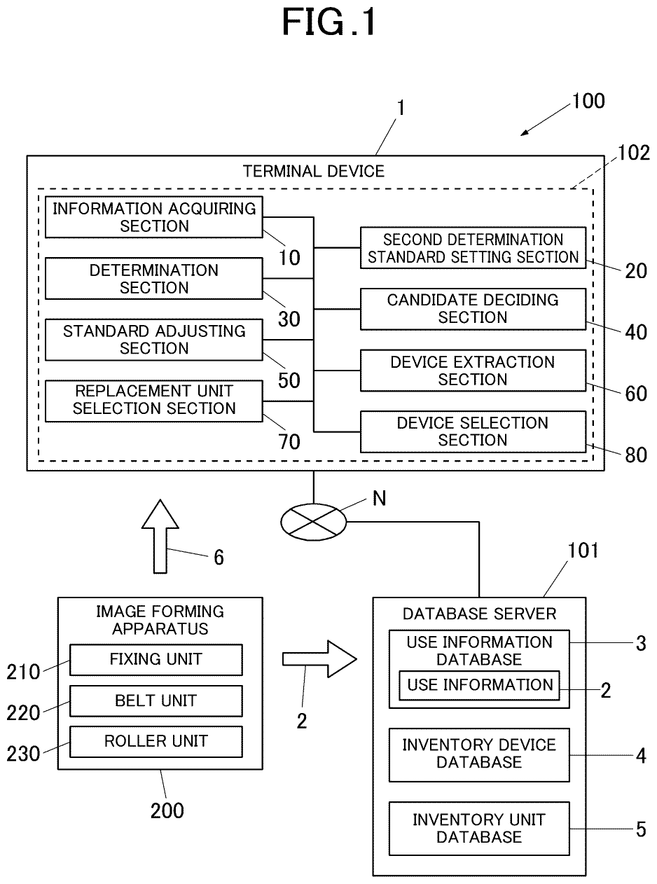

FIG. 1 illustrates an outline of a system configuration in a reuse determination system 100 according to the present embodiment. As shown in FIG. 1, the reuse determination system 100 is mainly configured using a terminal device 1 (hardware processor).

The terminal device 1 is connected to a database server 101 via a communication network N. The database server 101 includes a use information database 3, an inventory device database 4, and an inventory unit database 5.

The use information database 3 collects use information 2 on a use status and use record of an image forming apparatus 200 by the user, and compiles a database from the use information 2 for storage. The inventory device database 4 manages inventory of an image forming apparatus in which maintenance is finished and the image forming apparatus as a reuse candidate. The inventory unit database 5 manages inventory of replacement units that can be allocated to other image forming apparatuses.

The terminal device 1 can acquire various types of information such as the use information 2 from the database server 101 via the communication network N.

The terminal device 1 includes a function of acquiring, directly or indirectly from the image forming apparatus 200, remaining lifetime information 6 on remaining lifetime of a plurality of units 210 and the like built in the image forming apparatus 200 (see FIG. 1).

According to the reuse determination system 100 of the present embodiment, a computer terminal such as a well-known personal computer can be used as the terminal device 1. As the database server 101, a cloud server constructed in a cloud environment can be used.

By installing a reuse determination program 102 of the present disclosure in the terminal device 1 and activating it, the reuse determination system 100 of the present embodiment is constructed on the terminal device 1.

The terminal device 1 is not limited to the above-described computer terminal, and various information communication terminals such as well-known tablet terminals and smartphone terminals can be used. By installing the reuse determination program 102 in the information communication terminal as an application, the reuse determination system 100 of the present embodiment can be constructed on the information communication terminal.

All or some of the functions of the terminal device 1 may be formed in the image forming apparatus 200. All or some of the functions of the terminal device 1 may be formed on a cloud or a known server connected to the communication network N. For example, by constructing all or a part of the functions of the reuse determination system 100 in the image forming apparatus 200, it is possible to easily check whether reuse is possible or not in an office or the like where it is installed.

The database server 101 is not limited to one constructed on the cloud, but may be one using a well-known server device. The use information database 3 and the like may be stored in a storage section configured inside the terminal device 1.

The terminal device 1 can be installed in a management company that performs maintenance or the like on the image forming apparatus collected from an office or the like and manages the image forming apparatus as a maintenance finished image forming apparatus (refurbished machine). The management company also removes a usable unit from the collected image forming apparatus and manages the inventory of the unit as the replacement unit.

For the image forming apparatus 200 collected from the office or the like, the reuse determination system 100 according to the present embodiment is implemented by using the terminal device 1 installed in a managing and operating company.

The timing at which whether or not the image forming apparatus 200 can be reused is determined is not particularly limited. For example, the determination of reuse can be performed at the timing of being collected from the office or the like and transported to the above-described managing and operating company. Alternatively, the collected image forming apparatus 200 may be transported to the managing and operating company and then stored as it is in a warehouse or the like, and the reuse determination system 100 of the present embodiment may be executed at a timing decided by the user who is the new delivery destination.

### 2. Configuration of Reuse Determination System and Flow of Reuse Determination Process

As illustrated in FIG. 1, the terminal device 1 constituting the reuse determination system 100 of the present embodiment mainly includes an information acquiring section 10, a second determination standard setting section 20, a determination section 30, and a candidate deciding section 40. Furthermore, the terminal device 1 includes, as other components, a standard adjusting section 50, a device extraction section 60, a replacement unit selection section 70, and a device selection section 80.

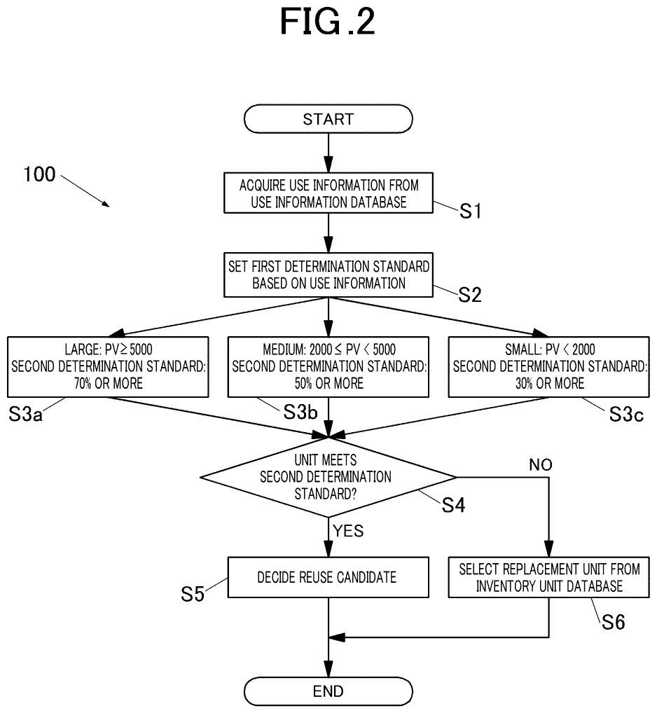

Hereinafter, each configuration of the terminal device 1 and a flow of a reuse determination process will be described with reference to a flowchart of FIG. 2.

The information acquiring section 10 includes a function that acquires from the use information database 3, the use information 2 on the use status and use record of the image forming apparatus 200 (information acquiring means S1).

That is, at a stage where the user to be the new delivery destination is decided, processing for acquiring, from the use information database 3, the use information 2 including the user's past use status, use record, and the like of the image forming apparatus 200 is performed.

The use information 2 includes information such as the number of printed sheets and the number of copies per month when the user used the image forming apparatus in the past. For example, the use information 2 can be acquired using a counter function installed in the image forming apparatus 200.

In the reuse determination system 100 according to the present embodiment, a case where the terminal device 1 acquires, as the use information 2 on the user decided as the new delivery destination, information on the number of sheets used per month in the past use of the image forming apparatus 200 will be illustrated.

The second determination standard setting section 20 (first determination standard setting means S2) includes the function to set first determination standards 21, which is classified in stages in advance, based on the use information 2 acquired by the information acquiring section 10 (information acquiring means S1). Furthermore, the second determination standard setting section 20 (second determination standard setting means S3a, S3b, S3c) includes the function to set second determination standards 22 in accordance with the set first determination standard 21.

Based on monthly printing in the use of the image forming apparatus 200 by the user included in the acquired use information 2, the first determination standard 21 preliminarily classified into stages is set.

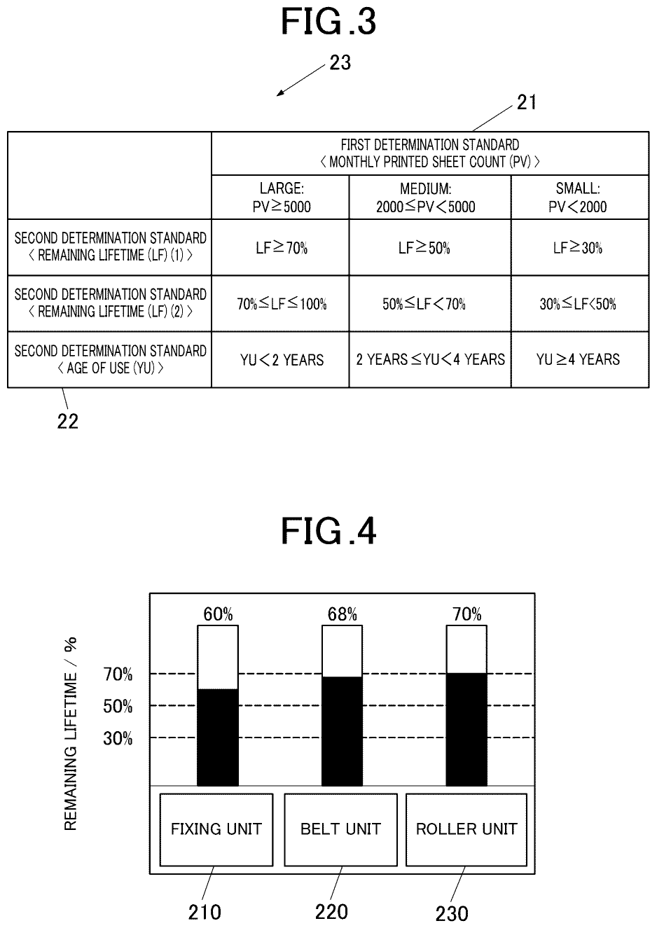

As illustrated in a determination standard table 23 in FIG. 3, the reuse determination system 100 according to the present embodiment adopts a classification setting in three stages which are “large”, “medium”, and “small” according to a magnitude of a monthly printed sheet count (PV) of the user.

As illustrated in FIG. 3, the classification is set as “large” when the monthly printed sheet count included in the use information 2 is 5000 or more, as “medium” when the monthly printed sheet count is 2000 or more and less than 5000, and as “small” when the monthly printed sheet count is less than 2000. Here, in some parts of FIG. 2 and FIG. 3, the monthly printed sheet count is illustrated with an ellipsis such as “PV (Print Volume)”.

Furthermore, in the determination standard table 23, the second determination standards 22 are respectively set so as to correspond to the classification of the first determination standard 21 on a horizontal axis. The second determination standards 22 can be set for each of several different cases with respect to the first determination standard 21.

For example, in the determination standard table 23 of FIG. 3, “remaining lifetime (1)” is shown as one example of the second determination standard 22. That is, a condition satisfied by the remaining lifetime of the unit 210 or the like incorporated in the image forming apparatus 200 is set in accordance with the stepwise classification of “large”, “medium”, and “small” of the first determination standard 21.

In the case of a remaining lifetime (1), the second determination standard 22 is set to “the remaining lifetime (LF) of the unit is 70% or more” corresponding to “large” of the first determination standard 21. Similarly, the second determination standard 22 is set to “the remaining lifetime of the unit is 50% or more” corresponding to “medium” of the first determination standard 21, and the second determination standard 22 is set to “the remaining lifetime of the unit is 30% or more” corresponding to “small” of the first determination standard 21. Here, in some parts of FIG. 2 and FIG. 3, the remaining lifetime is illustrated with an ellipsis such as “LF (Life)”.

The reuse determination system 100 sets the first determination standard 21 based on the use information 2 by the first determination standard setting means S2 and then sets the second determination standard 22 according to the determination standard table 23 set in advance (second determination standard setting means S3a, S3b, and S3c).

The determination section 30 includes the function to determine whether each of the units (the fixing unit 210, the belt unit 220, and the roller unit 230) included in the image forming apparatus 200 as a determination target satisfies the second determination standard 22 (determination means S4).

The remaining lifetime information 6 on the remaining lifetime of each of the units 210 and the like of the image forming apparatus 200 as the determination target is acquired by the terminal device 1 as described above.

In the image forming apparatus 200 as the determination target, when all the units 210 and the like satisfy the second determination standard 22 (YES in the determination means S4), the image forming apparatus 200 including the units 210 and the like is decided as a reuse candidate (candidate deciding means S5). The image forming apparatus 200 is registered as the reuse candidate in the inventory device database 4 of the database server 101.

The candidate deciding section 40 includes a function to decide the reuse candidate on the basis of the determination result by the determination section 30 (determination means S4) (candidate deciding means S5).

On the other hand, when at least one of the units 210 or the like does not satisfy the second determination standard 22 (NO in the determination means S4), the image forming apparatus 200 is excluded from the reuse candidate, and the process proceeds to the processing of the replacement unit selection means S6.

The replacement unit selection section 70 includes the function to select the replacement unit for replacing the unit 210 or the like that does not satisfy the second determination standard 22 from the inventory unit database 5 of the database server 101 (replacement unit selection means S6).

Even the image forming apparatus 200 that is not the reuse candidate can be registered and used as the reusable image forming apparatus 200 by selecting, from the inventory unit database 5, the replacement unit that satisfies the second determination standard 22 and assigning the selected replacement unit to the image forming apparatus 200.

Through the above-described processing, whether the image forming apparatus 200 can be reused is determined. That is, on the basis of the two determination standards which are the first determination standard 21 set on the basis of the use information 2 and the second determination standard 22 set in accordance with the first determination standard 21, whether or not the image forming apparatus 200 can be reused is determined.

Thus, the image forming apparatus 200 that is more appropriate as the reuse candidate can be decided on the basis of the use information 2 of the user than in a conventional case where reuse of the image forming apparatus 200 is decided on the basis of only the remaining lifetime of the unit as the determination standard.

Furthermore, even the image forming apparatus 200 that has not become the reuse candidate can be registered and managed as the reuse candidate by assigning the appropriate replacement unit. Thus, resources can be effectively used.

In the reuse determination system 100 according to the present embodiment, the number of sheets used per month (monthly printed sheet count) is used as the use information 2, but the use information 2 is not limited to this. As described above, as the use information 2, information based on the use record or the like other than the monthly printed sheet count of the past of the user who uses the image forming apparatus 200 can be appropriately used.

Furthermore, the number of sheets used included in the use information 2 may include, for example, a number per month of the following, the number of copied sheets, the number of printed sheets, the number of facsimiles received, the number of facsimiles transmitted, and the number of sheets read by a scanner. Thus, the user's use status, use record, and the like can be grasped in detail, and high accuracy use information 2 can be acquired.

The second determination standard 22 can be set to include an upper limit value and a lower limit value. For example, as shown in “remaining lifetime (2)” of the determination standard table 23 of FIG. 3, the remaining lifetime can be specified in a range between the upper limit value and the lower limit value.

For example, assume a case of image forming apparatus A, B, and C in which the remaining lifetime of the fixing unit 210, the belt unit 220, and the roller unit 230 are as illustrated in FIG. 4 to FIG. 6, respectively. FIG. 4 to FIG. 6 are explanatory diagrams schematically illustrating the remaining lifetime of each of the units 210 and the like included in the image forming apparatus 200.

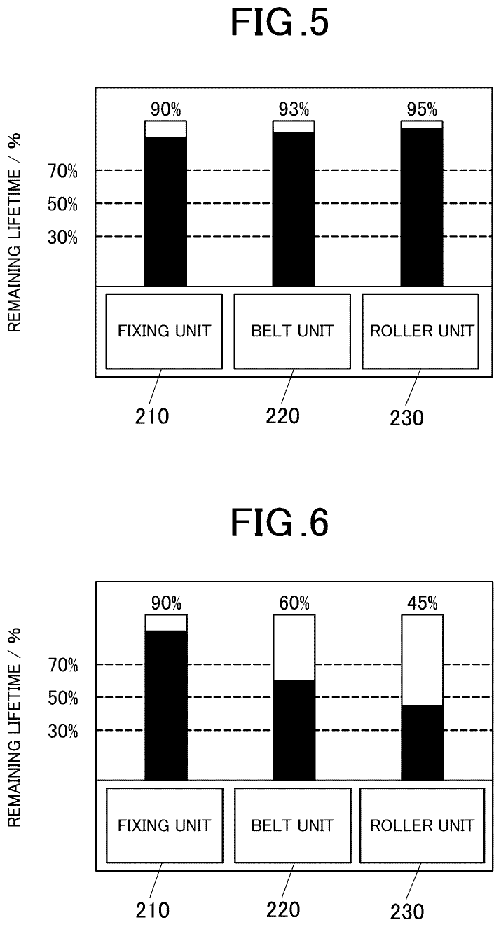

In this case, if the first determination standard 21 is “large” based on the above-described use information 2, the second determination standard 22 of “the remaining lifetime (LF) of the unit is 70% or more” is set. Therefore, only the image forming apparatus B in FIG. 5 satisfying the condition that the remaining lifetime of all the units are 70% or more is selected as the reuse candidate.

On the other hand, when the first determination standard 21 is “medium”, the second determination standard 22 of “the remaining lifetime of the unit is 50% or more” is set. Therefore, the two image forming apparatus A and B in FIG. 4 and FIG. 5 satisfying the condition that the remaining lifetime of all the units are 50% or more are selected as reuse candidates.

Further, when the first determination standard 21 is “small”, the second determination standard 22 of “the remaining lifetime of the unit is 30% or more” is set. Therefore, the three image forming apparatus A, B, and C in FIG. 4 to FIG. 6 satisfying the condition that the remaining lifetime of all the units are 30% or more are selected as the reuse candidates.

As described above, in the case where the range between the upper limit value and the lower limit value is not set in the second determination standard 22, a plurality of image forming apparatus 200 may be decided as the reuse candidates, making it difficult to judge which of the plurality of image forming apparatus 200 is to be selected as an optimum reuse candidate.

Therefore, the second determination standard 22 is set to include the upper limit value and the lower limit value. For example, when the first determination standard 21 is “medium”, the second determination standard 22 of “the remaining lifetime of the unit is 50% or more and less than 70%” is set. As a result, only the image forming apparatus A in FIG. 4 becomes the reuse candidate.

Setting the second determination standard 22 so as to include the upper limit value and the lower limit value makes it possible to select, from among the plurality of image forming apparatuses, the image forming apparatus that is the most appropriate candidate for reuse in accordance with the use status by the user.

Further, in the above description, the remaining lifetime (1) or the remaining lifetime (2) relating to the remaining lifetime of the unit 210 or the like is set as the second determination standard 22, but the present disclosure is not limited thereto. For example, the second determination standard 22 may be set based on an age of use of the image forming apparatus 200 that is the determination target (refer to the determination standard table 23 in FIG. 3). That is, the second determination standard 22 is not limited to the determination standard for the unit, but may be the determination standard for the image forming apparatus itself.

In this case, the second determination standard 22 can be set to a condition that the age of use of the image forming apparatus 200 is less than two years, corresponding to “large” of the first determination standard 21. Hereinafter, the second determination standard 22 can be set to the condition that the age of use is two years or more and less than four years corresponding to “medium” and the condition that the age of use is four years or more corresponding to “small”.

In a case where the age of use of the image forming apparatus 200 is short, damage to the respective units 210 and the like is obviously small, and the risk of occurrence of malfunction or the like is low. Therefore, it is preferable to install the image forming apparatus for the user with the large monthly printed sheet count.

On the other hand, in a case where the age of use of the image forming apparatus 200 is long, the degree of wear of each of the units 210 and the like becomes high, and the image forming apparatus 200 may not be suitable for installation for the user with the large monthly printed sheet count. For this reason, it is preferable that the user having a small monthly printed sheet count is set as the candidate for a reuse destination of the image forming apparatus 200.

The standard adjusting section 50 constituting the terminal device 1 has the function of being able to arbitrarily adjust at least one of the first determination standard 21 and/or the second determination standard 22.

That is, adjusting the above-described upper and lower limit values and the like related to the first determination standard 21 and/or the second determination standard 22 to arbitrary values can enable selection of the image forming apparatus 200 suitable for the user expected to use the image forming apparatus 200 in a special use status. For example, it is possible to set the first determination standard 21 and/or the second determination standard 22 with conditions suitable for the user who mainly performs printing of a postcard size.

The device extraction section 60 includes the function to extract the image forming apparatus 200 having a large number of units satisfying the second determination standard 22 from the image forming apparatuses 200 excluded from the reuse candidates based on the determination result by the determination section 30 (device extraction means S7).

The image forming apparatus 200 is configured to include a plurality of units 210 and the like. Therefore, many cases are assumed in which the image forming apparatus 200 is excluded from the reuse candidate by the determination section 30. For example, it is assumed that none of the units 210 or the like satisfies the second determination standard 22. On the other hand, it is assumed that only one or several units 210 or the like among the plurality of units 210 or the like do not satisfy the second determination standard.

Therefore, the image forming apparatus 200 in which the number of units satisfying the second determination standard 22 is large, for example, 50% or more of the total number of units satisfy the second determination standard 22 is extracted from the image forming apparatus 200 excluded from the reuse candidate.

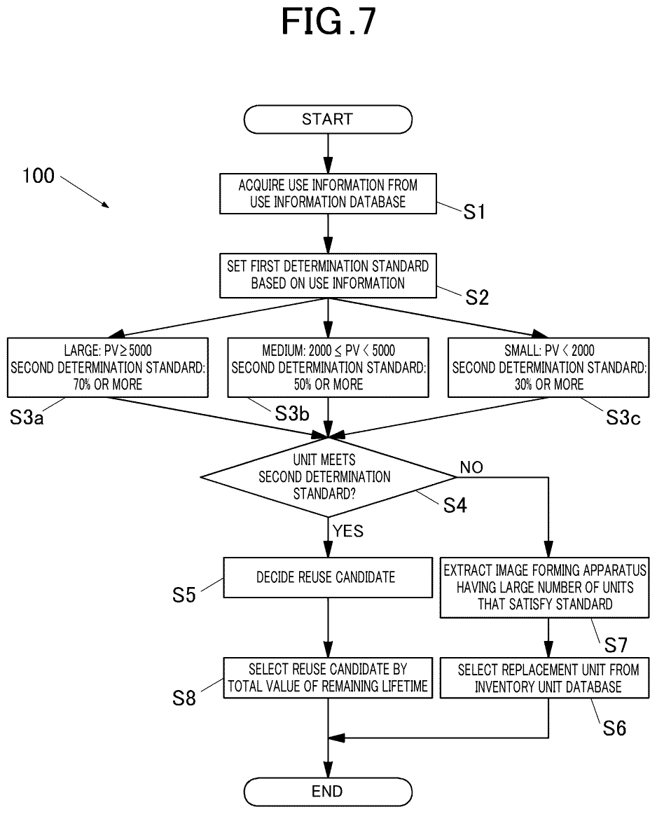

As illustrated in FIG. 7, the extraction processing by the device extraction section 60 (device extraction means S7) is performed between the determining processing by the determination section 30 (determination means S4) and the above-described selection processing of the replacement unit by the replacement unit selection section 70 (replacement unit selection means S6). Thus, it is possible to efficiently select the replacement unit.

The device selection section 80 includes the function to select the image forming apparatus 200 having the smallest total value of the remaining lifetime of the plurality of units 210 or the like from among the image forming apparatuses 200 determined to be the reuse candidates by the candidate deciding section 40 (device selection means S8).

For example, when the three image forming apparatuses A, B, and C illustrated in FIG. 4 to FIG. 6 are decided as the reuse candidates, it may not be possible to judge which image forming apparatus is to be delivered to the user.

In this case, the image forming apparatus 200 in which the total value of the remaining lifetime of the plurality of units 210 or the like is the minimum can be selected as the reuse candidate. For example, the total value of the remaining lifetime of the fixing unit 210, the belt unit 220, and the roller unit 230 in each of the image forming apparatus A, B, and C in FIG. 4 to FIG. 6 is as follows.

That is, the total remaining lifetime value of the image forming apparatus A is “198%”, the total remaining lifetime value of the image forming apparatus B is “278%”, and the total remaining lifetime value of the image forming apparatus C is “195%”.

Therefore, in the above case, the image forming apparatus C having the minimum total remaining lifetime value of “195%” is selected as the suitable reuse candidate by the device selection section 80 (device selection means S8). Thus, the image forming apparatus 200 incorporating the unit having the short remaining lifetime is promptly installed to the user, thus allowing effective use of resources.

As described above, the reuse determination system and the reuse determination program of the present disclosure can decide the image forming apparatus 200 that is to be the reuse candidate based on the two determination standards which are the first determination standard 21 and the second determination standard 22.

Further, by adjusting the first determination standard 21 and the second determination standard 22 to arbitrary values, the image forming apparatus 200 suitable for the new delivery destination can be effectively decided as the reuse candidate.

In addition, it is possible to select the more suitable image forming apparatus 200 from among the plurality of reuse candidate image forming apparatuses 200 based on the total value of the units 210 and the like. The image forming apparatus 200 excluded from the reuse candidates can be set as the reuse candidate image forming apparatus by replacing the unit that does not satisfy the second determination standard 22 with the replacement unit.

The reuse determination system and the reuse determination program according to the present disclosure can be useful in the managing and operating company that performs maintenance and inspection of the image forming apparatus.

Although embodiments of the present disclosure have been described and illustrated in detail, the disclosed embodiments are made for purposes of illustration and example only and not limitation. The scope of the present disclosure should be interpreted by terms of the appended claims.

What is claimed is:

1. A reuse determination system comprising:
a hardware processor,
wherein the hardware processor,
acquires use information of a user,
sets, based on the acquired use information, a second determination standard according to a first determination standard preliminarily classified in stages,
determines whether an image forming apparatus and/or a unit built in the image forming apparatus satisfies the set second determination standard, and
decides the image forming apparatus which is to be a reuse candidate based on a determination result.

2. The reuse determination system according to claim 1, wherein the use information includes a number of sheets used per month in the image forming apparatus by the user.

3. The reuse determination system according to claim 2, wherein the number of sheets used includes at least one of a number of copied sheets, a number of printed sheets, a number of facsimiles received, a number of facsimiles transmitted, and a number of sheets read by a scanner counted per month in the image forming apparatus.

4. The reuse determination system according to claim 1, wherein the second determination standard is set based on a remaining lifetime of the unit.

5. The reuse determination system according to claim 1, wherein the second determination standard is set based on an age of use of the image forming apparatus.

6. The reuse determination system according to claim 4, wherein the second determination standard is set in a range including an upper limit value and a lower limit value.

7. The reuse determination system according to claim 1, wherein the hardware processor is configured to be capable of arbitrarily adjusting at least one of the first determination standard and/or the second determination standard.

8. The reuse determination system according to claim 1, wherein,
the hardware processor extracts, based on a determination result, the image forming apparatus having a large number of the units satisfying the second determination standard from among the image forming apparatuses excluded from the reuse candidate, and
the hardware processor selects a replacement unit to be replaced with the unit that is built in the extracted image forming apparatus and that does not satisfy the second determination standard.

9. The reuse determination system according to claim 4, wherein the hardware processor selects the image forming apparatus having a smallest total value of the remaining lifetime of the units from among the image forming apparatuses determined to be the reuse candidate.

10. A non-transitory computer-readable storage medium including a reuse determination program that causes a computer to perform,
acquiring use information of a user,
setting, based on the acquired use information, a second determination standard according to a first determination standard preliminarily classified in stages,
determining whether an image forming apparatus and/or a unit built in the image forming apparatus satisfies the set second determination standard, and
deciding the image forming apparatus which is to be a reuse candidate based on a determination result.

11. The storage medium storing the reuse determination program according to claim 10, wherein the image forming apparatus functions as the computer.
